(19) United States
(12) Patent Application Publication
(10) Pub. No.: US 2025/0106512 A1
(43) Pub. Date: Mar. 27, 2025

(54) Sensor Shift Assembly for Camera Module

(71) Applicant: Apple Inc., Cupertino, CA (US)

(72) Inventors: Qiang Yang, Fremont, CA (US); Aurelien R Hubert, Saratoga, CA (US); Bin Zhu, Milpitas, CA (US)

(73) Assignee: Apple Inc., Cupertino, CA (US)

(21) Appl. No.: 18/474,123

(22) Filed: Sep. 25, 2023

(51) Int. Cl. H04N 23/68; G03B 17/02; H04N 23/51; H04N 23/55

(52) U.S. Cl. CPC H04N 23/687; G03B 17/02; H04N 23/51; H04N 23/55

(57) ABSTRACT

A camera is provided. The camera includes an optical assembly having one or more lens defining an optical axis. The camera also includes an image sensor and an enclosure forming an exterior wall of the camera. The camera further includes an actuator assembly to move the image sensor relative to the optical assembly. In addition, the camera includes a base that is a static component of the camera, wherein the base comprises a seat that faces in a direction that is parallel to the optical axis and away from the optical assembly. The camera also includes a flexure that is attached to the seat, that suspends the image sensor from the base, and that allows motion of the image sensor enabled by the actuator assembly. In some cases, the base does not extend between the flexure and the enclosure.

### BACKGROUND

### Technical Field

This disclosure relates generally to a sensor shift camera module for actuation of an image sensor.

### Description of the Related Art

The advent of small, mobile multipurpose devices such as smartphones and tablet or pad devices has resulted in a need for high-resolution, small form factor cameras for integration in the devices. Some cameras may incorporate optical image stabilization (OIS) mechanisms that may sense and react to external excitation/disturbance by adjusting location of the optical lens and/or the image sensor on the X and/or Y axis in an attempt to compensate for unwanted motion of the lens. Furthermore, some cameras may incorporate an autofocus (AF) mechanism whereby the object focal distance can be adjusted to focus an object plane in front of the camera at an image plane to be captured by the image sensor. In some such AF mechanisms, the optical lens and/or the image sensor is moved as a single rigid body along the optical axis of the camera to refocus the camera.

### BRIEF DESCRIPTION OF THE DRAWINGS

FIG. 1 illustrates components of an example camera having an actuator module or assembly that may, for example, be used to provide autofocus and/or optical image stabilization through image sensor movement in small form factor cameras, according to at least some embodiments. FIG. 1 shows an overhead view of the exterior of the camera.

FIGS. 2A and 2B illustrate components of an example camera having an actuator module or assembly that may, for example, be used to provide autofocus and/or optical image stabilization through image sensor movement in small form factor cameras, according to at least some embodiments. FIG. 2A shows a cross-sectional view of the camera across the A-A plane. FIG. 2B shows an exploded view of the camera.

FIGS. 3 and 4 illustrate components of another example camera having an actuator module or assembly that may, for example, be used to provide autofocus and/or optical image stabilization through image sensor movement in small form factor cameras, according to at least some embodiments.

FIG. 3 shows a cross-sectional view of the camera across the A-A plane.

FIG. 4 shows an exploded view of the camera.

FIGS. 5 and 6 illustrate components of another example camera having an actuator module or assembly that may, for example, be used to provide autofocus and/or optical image stabilization through image sensor movement in small form factor cameras, according to at least some embodiments.

FIG. 5 shows a cross-sectional view of the camera across the A-A plane.

FIG. 6 shows an exploded view of the camera.

FIG. 7 illustrates a cross-sectional comparison between the camera illustrated in FIGS. 2A and 2B and the camera illustrated in FIGS. 3 and 4.

FIG. 8 illustrates a cross-sectional comparison between the camera illustrated in FIGS. 2A and 2B and the camera illustrated in FIGS. 5 and 6.

FIG. 9 illustrates a schematic representation of an example device that may include a camera, in accordance with some embodiments.

FIG. 10 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to an actuator assembly that may be used in a camera with a moveable image sensor. In some examples, the camera may include camera equipment outfitted with controls, magnets, flexures, and voice coil motors to improve the effectiveness of a miniature actuation mechanism for a compact camera module. More specifically, in some embodiments, compact camera modules include actuators to deliver functions such as autofocus (AF) and optical image stabilization (OIS). One approach to delivering a very compact actuator for OIS and AF is to use a Voice Coil Motor (VCM) arrangement.

In some embodiments, actuator assemblies may be used provide AF and/or OIS for a camera. In some aspects, an axial actuator may drive an optical assembly having one or more lenses in one or more directions parallel to an optical axis (e.g., z-direction(s)) to provide autofocus. A transversal actuator, separate from the axial actuator, may drive an optical assembly and/or an image sensor in one or more directions orthogonal to an optical axis (e.g., x-direction(s), y-direction(s)) to provide OIS. In some OIS sensor shift actuators, the flexure retaining the image sensor may be attached to a top surface of a camera base. The camera base may be an insert molded base that includes a midframe inside that enforces the structure of the base mechanically and that provides an electrical connection for the ground. The flexure may need to be grounded by the enclosure by passing through the base. As such, there may be a molding thickness for the base which results in a large gap between the image sensor and the enclosure (e.g., outer wall) of the camera. The large gap formed between the image sensor and the enclosure may limit the amount of heat dissipation generated by the image sensor, and, thus, may limit the functionality of the sensor package and limit a quantity of video modes that camera can support. In addition, the base thickness and the large gap may directly impact the module shoulder height and lens top height impacting system fit.

As described herein, the flexure retaining the image sensor may be attached to a base of the camera with a relatively thin width so that the base does not extend below the flexure (e.g., between the flexure and the enclosure). The flexure is attached to the base via a downward facing seat (e.g., a seat facing in a direction parallel to the optical axis and away from the optics assembly) on the base rather than an upward facing seat (e.g., a seat facing in a direction parallel to the optic axis and towards to the optics assembly). Due to the thinner base, the image sensor (or a sensor stiffener) may be grounded directly to the enclosure rather than through a midframe of the base (e.g., a fender). The flexure being attached to a downward facing seat of a base with a relatively thin dimension (e.g., width) such that the base does not extend below the flexure (e.g., a static platform) (e.g., between the flexure and the enclosure) may reduce the gap between the image sensor and the enclosure of the camera. The relatively small gap between the image sensor and the enclosure of the camera may increase heat dissipation onto the enclosure and, thus, improve the functionality of the sensor package and increase a quantity of video modes that the camera can support. Further, the relatively thin dimension (e.g., width) of the base such that the base does not extend between the flexure and the enclosure at least helps to produce the relatively smaller gap may also provide camera module/camera shoulder height savings for different sensor mounting configuration. In some embodiments, flexure mounting configurations may decrease the camera module height by about 250 microns (μm). In some embodiments, flexure mounting configurations may decrease the module height by about 400 μm. Additionally, in some embodiments, a wire bond may electrically connect the image sensor to the flexure for improved electronic signal transmissions. Further, the configurations described herein may reduce the warpage requirement for base molding and may allow for a variety of different base manufacturing processes including metal injection molding (MIM).

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

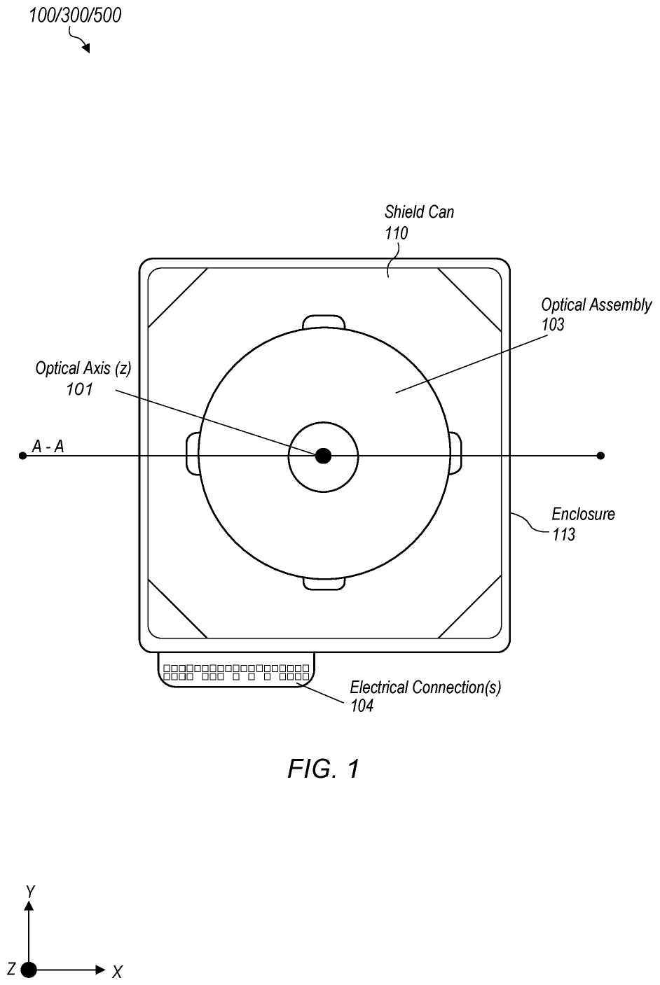

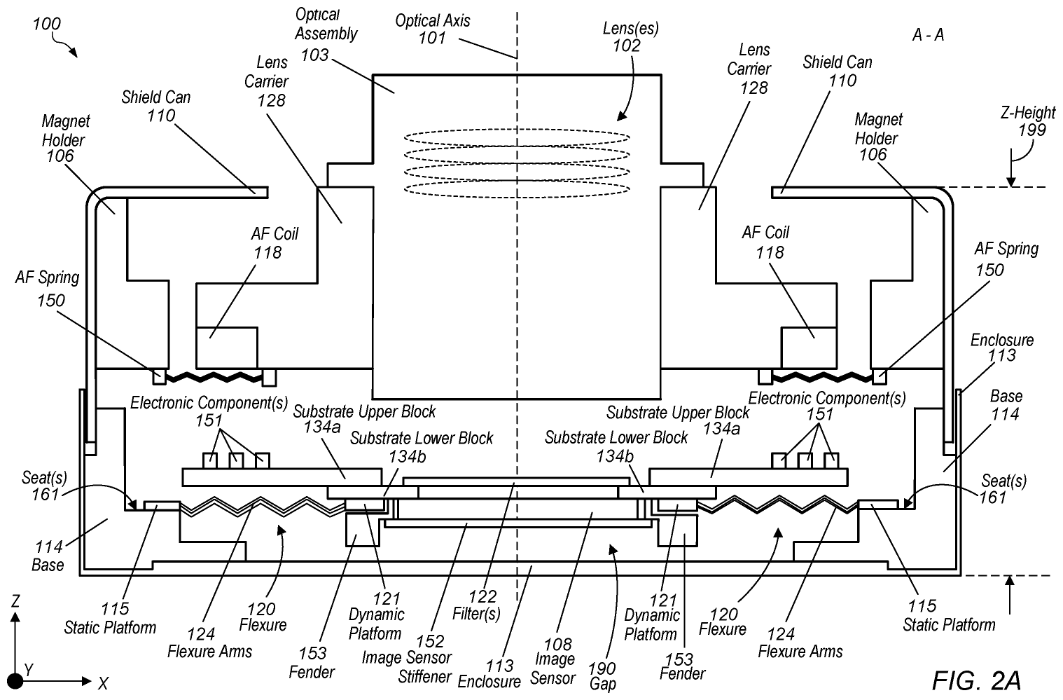

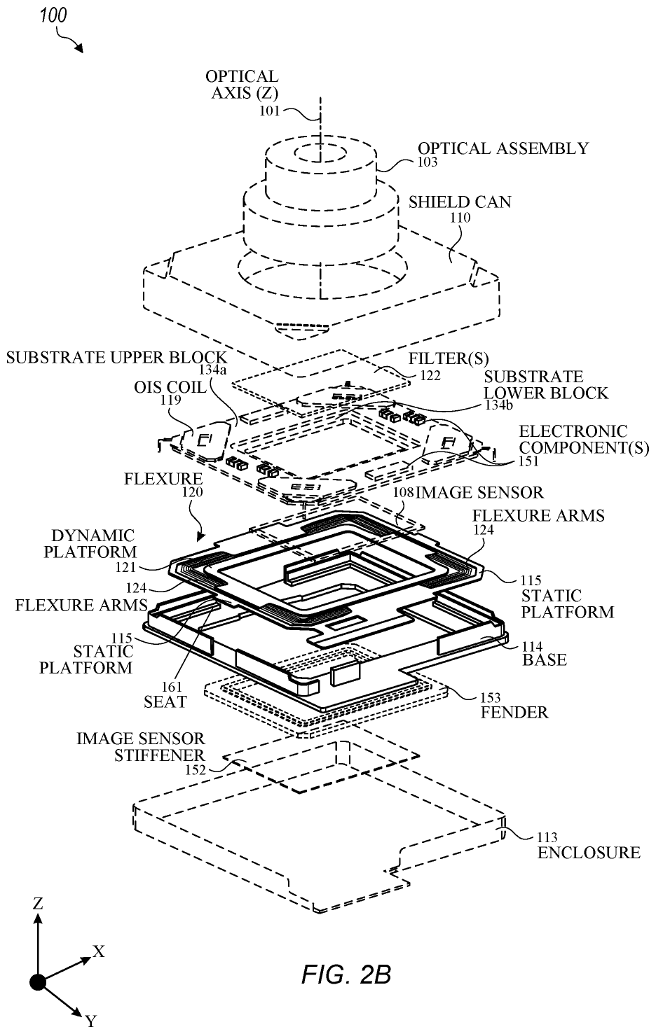

FIG. 1 illustrates components of an example camera 100/300/500 having an assembly that may, for example, be used to provide autofocus and/or optical image stabilization through image sensor movement in small form factor cameras, according to at least some embodiments. FIG. 1 shows an overhead view of the exterior of the camera. The camera 100/300/500 may include one or more same or similar features as the features described with respect to or illustrated in FIGS. 2A, 2B, 3, 4, 5, 6, 7, 8, 9, and 10. The example X-Y-Z coordinate system shown in FIG. 1 may be used to discuss aspects of components and/or systems, and may apply to embodiments described throughout this disclosure.

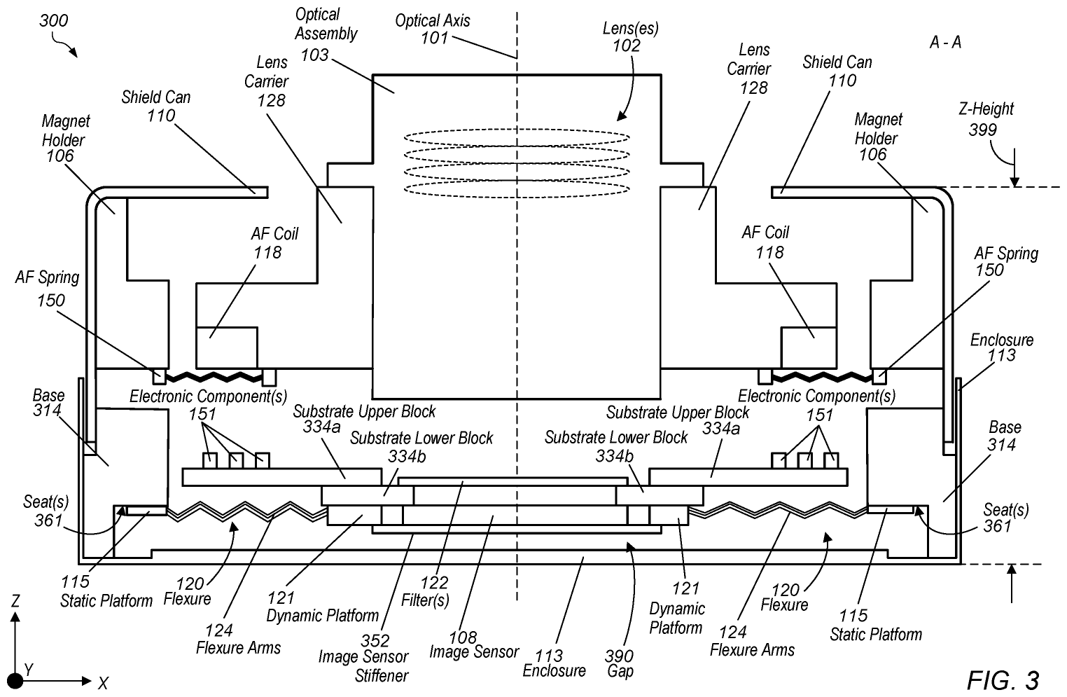

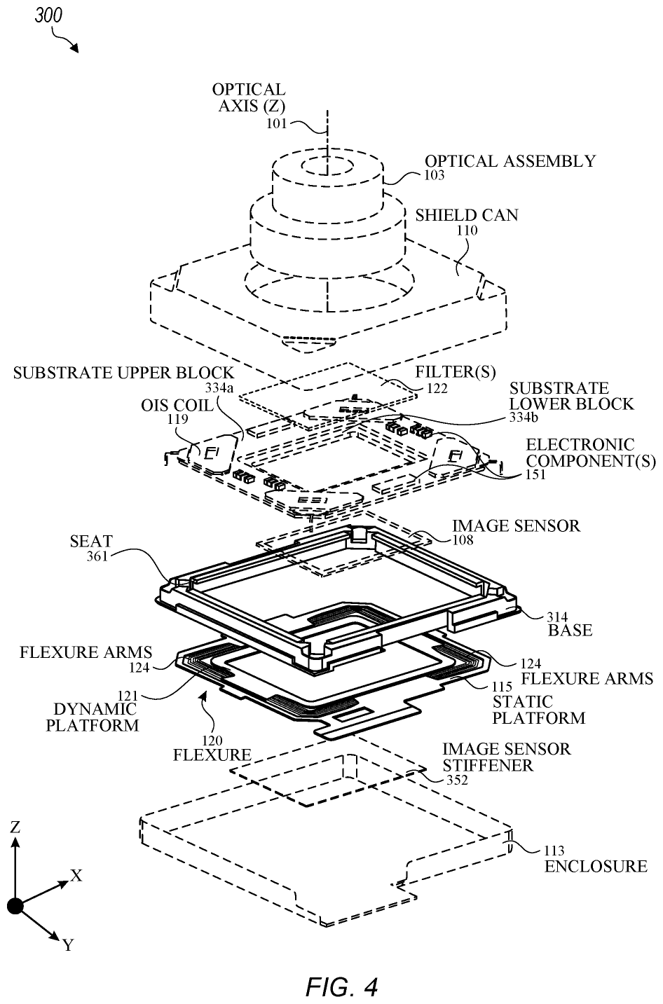

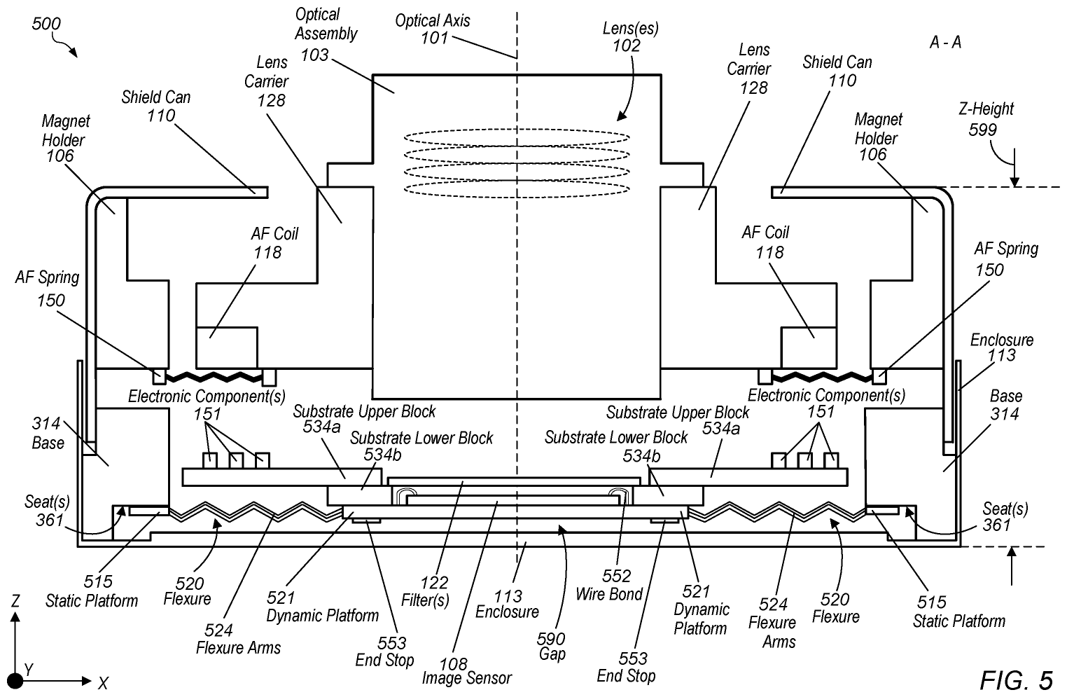

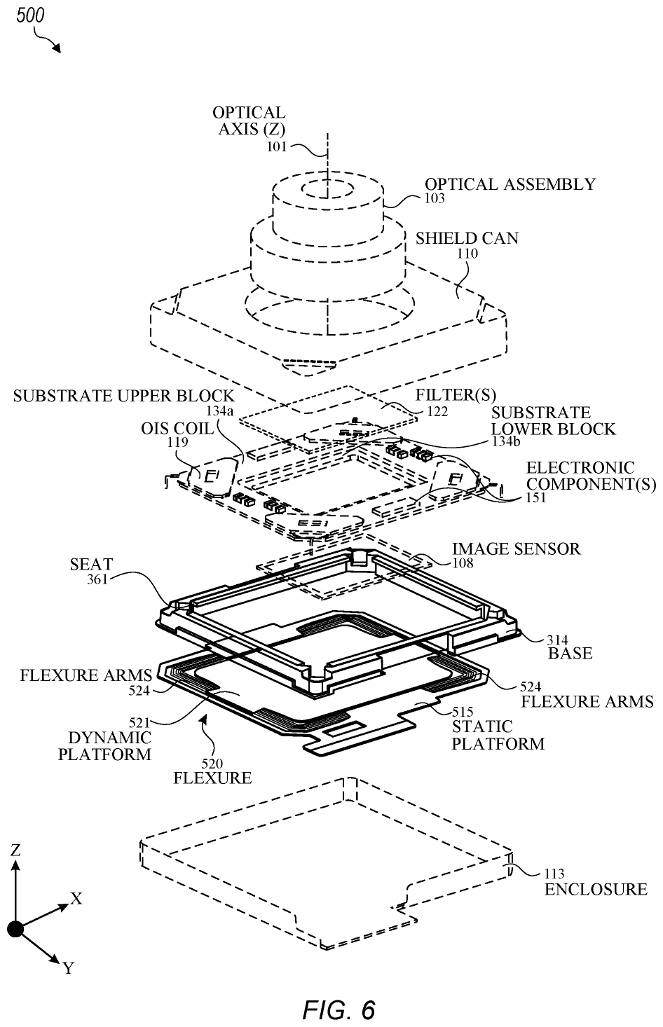

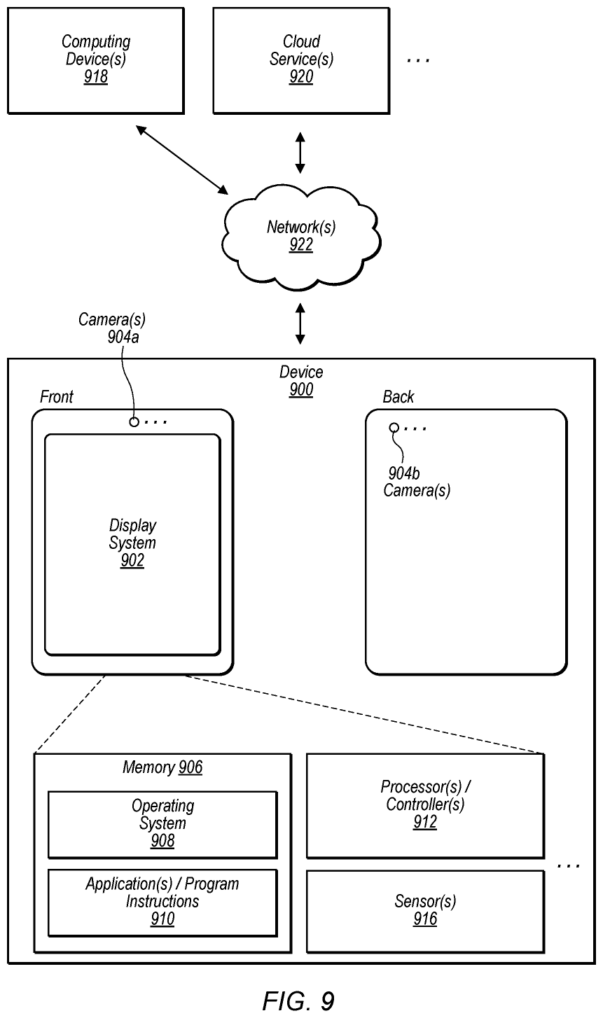

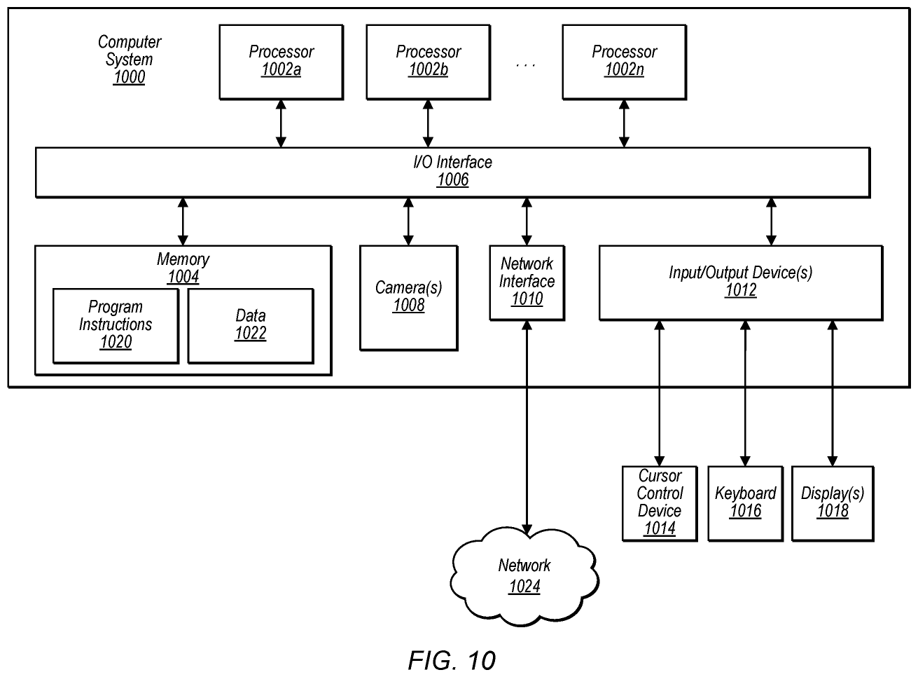

In various embodiments, the camera 100/300/500 may include an optical assembly 103 having one or more lenses 102 (as shown in FIGS. 2A, 3, and 5) defining an optical axis (z) 101, a shield can 110, an enclosure 113, and electrical connection(s) 104. The shield can 110 may be form an outer wall of a top portion (and in some cases side portions) of the camera 100/300/500 and form one or more camera shoulders. The enclosure 113 may form an outer wall of a bottom portion of the camera 100/300/500. The electrical connection(s) 104 may extend from the enclosure 113 (and shield can 110) and may electrically connect the camera 100/300/500 to an external device. For example, the camera 100/300/500 may be the same or similar camera as the camera 904b illustrated in FIG. 9 or the camera 1008 illustrated in FIG. 10. As such, the electrical connection(s) 104 may extend from the enclosure 113 and may electrically connected the camera 100/300/500 to the device 900 illustrated in FIG. 9 or the computer system 1000 illustrated in FIG. 10, respectively. In some aspects, the shield can 110 may be mechanically attached to a base (e.g., a base 114 illustrated in FIGS. 2A and 2B, a base 314 illustrated in FIGS. 3 and 4, and/or a base 514 illustrated in FIGS. 5 and 6). The shield can 110 may be mechanically coupled to the base via the enclosure 113 attached to both the shield can 110 and the base.

FIGS. 2A and 2B illustrate components of an example camera 100 having an assembly that may, for example, be used to provide autofocus and/or optical image stabilization through image sensor movement in small form factor cameras, according to at least some embodiments. FIG. 2A shows a cross-sectional view of the camera 100 across the A-A plane. FIG. 2B shows an exploded view of the camera 100. The camera 100 may include one or more same or similar features as the features described with respect to or illustrated in FIGS. 1, 3, 4, 5, 6, 7, 8, 9, and 10. The example X-Y-Z coordinate system shown in FIGS. 2A and 2B may be used to discuss aspects of components and/or systems, and may apply to embodiments described throughout this disclosure.

FIGS. 2A and 2B illustrate a camera 100 (e.g., a camera module) with a relatively larger gap 190 (e.g., compared to the gap 390 of the camera 300 of FIGS. 3 and 4 and compared to the gap 590 of the camera 500 of FIGS. 5 and 6) between the image sensor 108 and the enclosure 113 of the camera 100. The relatively larger gap 190 formed between the image sensor 108 and the enclosure 113 of the camera 100 may limit the amount of heat dissipation through the enclosure 113 generated by the image sensor 108 and, thus, may limit the functionality of the sensor package and limit a quantity of video modes that the camera 100 can support. For example, the camera 100 may only be able to marginally support 4k/120 fps mode and may not be able to support 8k/30 fps mode. For instance, with the camera 100, when the image sensor 127 uses a power mode of 4K120FPS, the peak temperature at the image sensor may be 70.2 degrees Celsius. Conversely, with the camera 300 and/or the camera 500, when the image sensor 127 uses the power mode of 4K120FPS, the peak temperature at the image sensor may be 63.2 degrees Celsius. Thus, the configurations of cameras 300 and 500 is about 7 degrees Celsius less than the camera 100 when the image sensor 127 uses the power mode of 8K30FPS. As another instance, with the camera 100, when the image sensor 127 uses a power mode of 8K30FPS, the peak temperature at the image sensor may be 95.2 degrees Celsius. Conversely, with the camera 300 and/or the camera 500, when the image sensor 127 uses the power mode of 8K30FPS, the peak temperature at the image sensor may be 84.2 degrees Celsius. Thus, the configurations of cameras 300 and 500 is about 11 degrees Celsius less than the camera 100 when the image sensor 127 uses the power mode of 8K30FPS. In addition, the thickness of the base 114 below the static platform 115 of the flexure 120 providing structural support for the upward facing seat 161 coupling of the static platform 115 and producing the larger gap 190 may directly impact the camera shoulder height 199 and lens top height impacting system fit.

As shown in FIGS. 2A and 2B, the camera 100 includes an optical axis 101, and an optical assembly 103 including one or more lens(es) 102. A lens carrier 128 may retain the optical assembly 103. The lens carrier 128 may include one or more auto focus (AF) coil(s) 118 positioned circumferentially around the optical assembly 103 and the optical axis 101. A magnet holder 106 may be fixedly attached to a static shield can 110. The magnet holder 106 may include one or more magnets for magnetically interacting with the AF coil(s) 118 when current flows through the AF coil(s) 118 to move the lens carrier 128 and the optical assembly 103 along the optical axis (z) 101 for auto focus. The magnets and AF coil(s) 118 may together be considered voice coil motor (VCM) actuators that utilize Lorentz forces to move the lens carrier 128 and the optical assembly 103 along the optical axis (z) 101 for auto focus. When Lorentz forces cause movement of the lens carrier 128 and the optical assembly 103 along the optical axis 101, respective AF springs 150 fixedly attached to the magnet holder 106 (and thus a static portion of the camera 100) and fixedly attached to the lens carrier 128 may be used to dampen movement of the lens carrier 128 and the optical assembly 103 along the optical axis 101 relative to the magnet holder 106 and/or the shield can 110.

The camera 100 also includes an image sensor 108, one or more filter(s) 122a, a sensor stiffener 152, a substrate 134 (e.g., an OIS FPC, printed circuit board, and/or the like) including an upper substrate 134a and a lower substrate 134b, a flexure 120, a fender 153, a base 114, the shield can 110, and an enclosure 130. The shield can 110 may be mechanically attached to the base 114. The shield can 110 may be mechanically coupled to the base 114 via the enclosure 113 attached to both the shield can 110 and the base 114. The flexure 120 may include a dynamic platform 121, a static platform 115, and a plurality of flexure arms 124. The image sensor 108 may be retained by the dynamic platform 121 so that image sensor 108 moves as the dynamic platform 121 moves relative to a static portion of the camera 100. The plurality of flexure arms 124 may provide a flexible mechanical coupling between the static platform 115 and the dynamic platform 121. For example, the flexure arms 124 may allow the dynamic platform 121 (and thus the image sensor 108) to move in one or more directions orthogonal to the optical axis 101 relative to the static platform 115 (e.g., a remainder of the camera 100) using one or more transversal actuators. For example, OIS coils 119 (e.g., as shown in FIG. 2B) positioned on the substrate 134 may interact with magnets in the magnet holder 106 to create Lorentz forces to move the dynamic platform 121 and the image sensor 108 in one or more directions orthogonal to the optical axis 101 relative to the static platform 115 (e.g., a remainder of the camera 100). In some aspects, the flexure arms 124 may allow the dynamic platform 121 (and thus the image sensor 108) to move in one or more directions parallel to or along the optical axis 101 relative to the static platform 115 (e.g., a remainder of the camera 100) using one or more axial actuators. A fender 153 may prevent the dynamic platform 121 and the image sensor from moving axially away from the optical assembly and making direct contact with the enclosure 113. Additionally, the flexure arms 124 may allow the dynamic platform 121 (and thus the image sensor 108) to move in one or more angular directions about one or more axes orthogonal to the optical axis 101 relative to the static platform 115 (e.g., a remainder of the camera 100) using one or more axial actuators. A sensor stiffener 152 may be used to provide the image sensor 108 with rigidity during movement as described herein.

In some aspects, the flexure arms 124 may include electrical traces for communicating electrical power and electrical signals between the dynamic platform 121 (e.g., one or more electronic components (e.g., electronic components 151) mounted (e.g., surface mounted) on the substrate (e.g., substrate upper block 134a), the image sensor 108 mounted on the substrate (e.g., the substrate lower block 134b), one or more electronic components mounted to the dynamic platform 121, or the like) and the static platform 115. The static platform 115 may be fixedly attached to the base 114 via one or more seats 161. For example, the base 114 may include one or more seats 161 facing a direction parallel with the optical axis 101 and facing towards the optical assembly 103. The static platform 115 may reside on the seats 161 and may be in electrical communication with one or more other components of the camera 100 (e.g., via the electrical connection(s) 104 illustrated in FIG. 1) for performing one or more camera operations via the base 114.

In some non-limiting examples, the image sensor 108 may be attached to or otherwise integrated into the substrate 134, such that the image sensor 108 is connected to the OIS frame or flexure 120 via the substrate. For example, the dynamic platform 121 may retain the substrate (e.g., the substrate upper block 134a, the substrate lower block 134b) for mounting one or more electronic components 151 and/or the image sensor 108. In some aspects, the substrate 134 (e.g., the substrate upper block 134a and/or the substrate lower block 134b) may be formed of ceramic. The substrate 134 may include an opening with a cross-section sized to permit light to pass therethrough while also receiving or retaining the filter(s) 122 and the image sensor 108. An upper surface of the substrate 134 (e.g., of the substrate lower block 134b) may retain the filter(s) 122 around a perimeter of the opening and a lower surface of the substrate (e.g., of the substrate lower block 134b) may retain the image sensor 108 around the perimeter of the opening. The substrate lower block 134b may couple the image sensor 108 to the substrate upper block 134a. With a lower surface of the substrate 134 retaining the image sensor 108 around the perimeter of the opening, the image sensor 108 may be connected (e.g., mechanically and/or electrically) to the flexure 120 via the substrate 134. This configuration may allow the substrate to retain the image sensor 108 (and the filter(s) 122) while also allowing light to pass from the lens(es) of the optics assembly 103, through the filter(s) 122, and be received by the image sensor 108 for image capturing (e.g., a light receiving surface of the image sensor for image capturing). In other embodiments, the substrate 134 and the image sensor 108 may be separately attached to the OIS frame or flexure 120. For instance, a first set of one or more electrical traces may be routed between the substrate and the OIS frame or flexure 120. A second, different set of one or more electrical traces may be routed between the image sensor 108 and the OIS frame or flexure 120.

As described herein, FIGS. 2A and 2B illustrate a camera 100 (e.g., a camera module) with a relatively larger gap 190 (e.g., compared to the gap 390 of the camera 300 of FIGS. 3 and 4 and compared to the gap 590 of the camera 500 of FIGS. 5 and 6) between the image sensor 108 and the enclosure 113 of the camera 100. The relatively larger gap 190 formed between the image sensor 108 and the enclosure 113 of the camera 100 may limit the amount of heat dissipation through the enclosure 113 and generated by the image sensor 108 and, thus, may limit the functionality of the sensor package and limit a quantity of video modes that camera 100 can support. For example, the camera 100 may only be able to marginally support 4k/120 fps mode and may not be able to support 8k/30 fps mode.

The flexure 120 is attached to the base 114 such that the static platform 115 of the flexure 120 may be attached to the upward facing seat 161 (e.g., a seat facing in a direction parallel to the optical axis and towards the optical assembly and/or the lenses 102) of the base 114. The portion of the base 114 supporting the seat 161 may form a relatively thicker dimension (e.g., a width) of the base 114 and produce a relatively large gap 190 between the image sensor 108 (e.g., the sensor stiffener 152) and the enclosure 113. When flexure 120 and the image sensor 108 are moved downward along the optical axis 101 and away from the optical assembly 103, the substrate 134 (e.g., the substrate lower block 134b) may be ground against the fender 153 creating at least part of the gap 190 between the image sensor 108 and the enclosure 113. The flexure 120 attached to the upward facing seat 161 of the base 114 with a relatively thick width such that the base 114 at least partially extends below the flexure 120 (e.g., the static platform 115) (e.g., between the flexure and the enclosure) may result in a relatively large gap 190 between the image sensor 108 and the enclosure 113 of the camera 100. The relatively large gap 190 between the image sensor 108 and the enclosure 113 of the camera 100 may decrease heat dissipation onto the enclosure 113 and, thus, limit the functionality of the sensor package and limit a quantity of video modes that the camera 100 can support. For example, the camera 100 may only be able to marginally support 4k/120 fps mode and may not be able to support 8k/30 fps mode. Further, the relatively thicker base 114 at least helping to produce the relatively larger gap 190 may provide relatively greater z-height 199 of the camera module/camera shoulder height.

FIGS. 3 and 4 illustrate components of an example camera 300 having an assembly that may, for example, be used to provide autofocus and/or optical image stabilization through image sensor movement in small form factor cameras, according to at least some embodiments. FIG. 3 shows a cross-sectional view of the camera 300 across the A-A plane. FIG. 4 shows an exploded view of the camera 300. The camera 300 may include one or more same or similar features as the features described with respect to or illustrated in FIGS. 1, 2A, 2B, 5, 6, 7, 8, 9, and 10. The example X-Y-Z coordinate system shown in FIGS. 3 and 4 may be used to discuss aspects of components and/or systems, and may apply to embodiments described throughout this disclosure. The flexure 120 retaining the image sensor 108 may be attached to a base 314 of the camera with a relatively thinner portion that does not extend below the flexure 120 (e.g., the static platform 115) (e.g., between the flexure 120 and the enclosure 113).

FIGS. 3 and 4 illustrate a camera 300 (e.g., a camera module) with a relatively smaller gap 390 (e.g., compared to the gap 190 of the camera 100 of FIGS. 2A and 2B) between the image sensor 108 and the enclosure 113 of the camera 300 and due at least in part to the absence of the fender 153 illustrated in FIGS. 2A and 2B. The relatively smaller gap 390 formed between the image sensor 108 and the enclosure 113 of the camera 300 may increase the amount of heat dissipation through the enclosure 113 generated by the image sensor 108 and, thus, may improve the functionality of the sensor package and increase a quantity of video modes that the camera 300 can support. For example, the camera 300 may be able to support 4K120FPS mode and may support 8K30FPS mode. For instance, with the camera 100, when the image sensor 127 uses a power mode of 4K120FPS, the peak temperature at the image sensor may be 70.2 degrees Celsius. Conversely, with the camera 300, when the image sensor 127 uses the power mode of 4K120FPS, the peak temperature at the image sensor may be 63.2 degrees Celsius. Thus, the configurations of camera 300 is about 7 degrees Celsius less than the camera 100 when the image sensor 127 uses the power mode of 4K120FPS. As another instance, with the camera 100, when the image sensor 127 uses a power mode of 8K30FPS, the peak temperature at the image sensor may be 95.2 degrees Celsius. Conversely, with the camera 300, when the image sensor 127 uses the power mode of 8K30FPS, the peak temperature at the image sensor may be 84.2 degrees Celsius. Thus, the configuration of camera 300 is about 11 degrees Celsius less than the camera 100 when the image sensor 127 uses the power mode of 8K30FPS. In addition, the flexure 120 (e.g., the static platform 115) attached to a downward facing seat 361 of the base 314 and the thinness of the base 314 below the static platform 115 of the flexure 120 such that the base does not extend below the flexure 120 (e.g., the static platform 115) (e.g., between the flexure 120 and the enclosure 113) may produce a relatively smaller gap 390 between the image sensor 108 and the enclosure 113 of the camera 300 relative to the gap 190. This smaller gap 390 directly reduces the camera shoulder height 399 and lens top height improving system fit.

As shown in FIGS. 3 and 4, the camera 300 includes an optical axis 101, and an optical assembly 103 including one or more lens(es) 102. A lens carrier 128 may retain the optical assembly 103. The lens carrier 128 may include one or more auto focus (AF) coil(s) 118 positioned circumferentially around the optical assembly 103 and the optical axis 101. A magnet holder 106 may be fixedly attached to a static shield can 110. The magnet holder 106 may include one or more magnets for magnetically interacting with the AF coil(s) 118 when current flows through the AF coil(s) 118 to move the lens carrier 128 and the optical assembly 103 along the optical axis (z) 101 for auto focus. The magnets and AF coil(s) 118 may together be considered voice coil motor (VCM) actuators that utilize Lorentz forces to move the lens carrier 128 and the optical assembly 103 along the optical axis (z) 101 for auto focus. When Lorentz forces cause movement of the lens carrier 128 and the optical assembly 103 along the optical axis 101, respective AF springs 150 fixedly attached to the magnet holder 106 (and thus a static portion of the camera 300) and fixedly attached to the lens carrier 128 may be used to dampen movement of the lens carrier 128 and the optical assembly 103 along the optical axis 101 relative to the magnet holder 106 and/or the shield can 110.

The camera 300 also includes an image sensor 108, one or more filter(s) 122a, a sensor stiffener 152, a substrate 334 (e.g., an OIS FPC, printed circuit board, and/or the like) including an upper substrate 334a and a lower substrate 334b, a flexure 120, a base 314, the shield can 110, and an enclosure 130. The shield can 110 may be mechanically attached to the base 314. The shield can 110 may be mechanically coupled to the base 314 via the enclosure 113 attached to both the shield can 110 and the base 314. The flexure 120 may include a dynamic platform 121, a static platform 115, and a plurality of flexure arms 124. The image sensor 108 may be retained by the dynamic platform 121 so that image sensor 108 moves as the dynamic platform 121 moves relative to a static portion of the camera 300. The plurality of flexure arms 124 may provide a flexible mechanical coupling between the static platform 115 and the dynamic platform 121. For example, the flexure arms 124 may allow the dynamic platform 121 (and thus the image sensor 108) to move in one or more directions orthogonal to the optical axis 101 relative to the static platform 115 (e.g., a remainder of the camera 300) using one or more transversal actuators. For example, OIS coils 119 (e.g., as shown in FIG. 4) positioned on the substrate 334 may interact with magnets in the magnet holder 106 to create Lorentz forces to move the dynamic platform 121 and the image sensor 108 in one or more directions orthogonal to the optical axis 101 relative to the static platform 115 (e.g., a remainder of the camera 300). In some aspects, the flexure arms 124 may allow the dynamic platform 121 (and thus the image sensor 108) to move in one or more directions parallel to or along the optical axis 101 relative to the static platform 115 (e.g., a remainder of the camera 300) using one or more axial actuators. The image sensor stiffener 352 may provide rigidity to the image sensor 108 and may be grounded into the enclosure 113 when the dynamic platform 121 and the image sensor 108 moving axially away from the optical assembly 103 along the optical axis 101. Additionally, the flexure arms 124 may allow the dynamic platform 121 (and thus the image sensor 108) to move in one or more angular directions about one or more axes orthogonal to the optical axis 101 relative to the static platform 115 (e.g., a remainder of the camera 300) using one or more axial actuators.

In some aspects, the flexure arms 124 may include electrical traces for communicating electrical power and electrical signals between the dynamic platform 121 (e.g., one or more electronic components (e.g., electronic components 151) mounted (e.g., surface mounted) on the substrate (e.g., substrate upper block 334a), the image sensor 108 mounted on the substrate (e.g., the substrate lower block 334b), one or more electronic components mounted to the dynamic platform 121, or the like) and the static platform 115. The static platform 115 may be fixedly attached to the base 314 via one or more seats 361. For example, the base 314 may include one or more seats 361 facing a direction parallel with the optical axis 101 and facing away from the optical assembly 103. The static platform 115 may reside on the seats 361 and may be in electrical communication with one or more other components of the camera 300 (e.g., via the electrical connection(s) 104 illustrated in FIG. 1) for performing one or more camera operations via the base 314.

In some non-limiting examples, the image sensor 108 may be attached to or otherwise integrated into the substrate 334, such that the image sensor 108 is connected to the OIS frame or flexure 120 via the substrate. For example, the dynamic platform 121 may retain the substrate (e.g., the substrate upper block 334a, the substrate lower block 334b) for mounting one or more electronic components 151 and/or the image sensor 108. In some aspects, the substrate 334 (e.g., the substrate upper block 334a and/or the substrate lower block 334b) may be formed of ceramic and an organic material. For example, the substrate upper block 334a may be formed of an organic material and the substrate lower block 334b may be formed of a ceramic material. The substrate 334 may include an opening with a cross-section sized to permit light to pass therethrough while also receiving or retaining the filter(s) 122 and the image sensor 108. An upper surface of the substrate 334 (e.g., of the substrate lower block 334b) may retain the filter(s) 122 around a perimeter of the opening and a lower surface of the substrate (e.g., of the substrate lower block 334b) may retain the image sensor 108 around the perimeter of the opening. The substrate lower block 334b may couple the image sensor 108 to the substrate upper block 334a. With a lower surface of the substrate 334 retaining the image sensor 108 around the perimeter of the opening, the image sensor 108 may be connected (e.g., mechanically and/or electrically) to the flexure 120 via the substrate 334. This configuration may allow the substrate to retain the image sensor 108 (and the filter(s) 122) while also allowing light to pass from the lens(es) of the optics assembly 103, through the filter(s) 122, and be received by the image sensor 108 for image capturing (e.g., a light receiving surface of the image sensor for image capturing). In other embodiments, the substrate 334 and the image sensor 108 may be separately attached to the OIS frame or flexure 120. For instance, a first set of one or more electrical traces may be routed between the substrate and the OIS frame or flexure 120. A second, different set of one or more electrical traces may be routed between the image sensor 108 and the OIS frame or flexure 120.

The camera 300 (e.g., a camera module) may have a relatively smaller gap 390 (e.g., compared to at least the gap 190 of the camera 100 of FIGS. 2A and 2B) between the image sensor 108 and the enclosure 113 of the camera 300. The relatively smaller gap 390 formed between the image sensor 108 (e.g., the image sensor stiffener 352) and the enclosure 113 of the camera 300 may enhance the amount of heat dissipation through the enclosure 113 generated by the image sensor 108 and, thus, may improve the functionality of the sensor package and increase a quantity of video modes that camera 300 can support (e.g., relative to the camera 100 of FIGS. 2A and 2B). For example, the camera 300 may improve the support 4k/120 fps mode and may support 8k/30 fps mode.

The flexure 120 may be attached to the base 314 such that the static platform 115 of the flexure 120 may be attached to the downward facing seat 361 (e.g., a seat facing in a direction parallel to the optical axis and away from the optics assembly and/or the lenses 102) of the base 314 rather than an upward facing seat (e.g., a seat facing in a direction parallel to the optic axis and towards to the optics assembly and/or the lenses 102, the seat 161 of FIGS. 2A and 2B) and may allow the image sensor 108 (e.g., and the image sensor stiffener 352) to move (e.g., away from the optical assembly 103 and/or the lenses 102) to the enclosure 113 so that the image sensor 108 (e.g., the image sensor stiffener 352) makes direct contact with the enclosure 113 rather than through a midframe of the base 314 (e.g., the base 114 of FIGS. 2A and 2B, the fender 153 of FIGS. 2A and 2B). The flexure 120 (e.g., the static platform 115) being attached to a downward facing seat 361 of the base 314 with a relatively thin portion that does not extend below the flexure 120 (e.g., the static platform 115) (e.g., between the flexure 120 and the enclosure 113) may produce a smaller gap 390 between the image sensor 108 and the enclosure 113 of the camera 300 relative to the gap 190. The gap 390 may be located between the image sensor 108 (e.g., the image sensor stiffener 352) and the enclosure 113 such that no object exists in the gap 309 between the image sensor 108 (e.g., the image sensor stiffener 352) and the enclosure 113. In other words, the image sensor 108 (e.g., the image sensor stiffener 352) may be the closest moving component of the camera 300 to the enclosure 113 (e.g., at or near the optical axis 101). The relatively small gap 390 between the image sensor 108 and the enclosure 113 of the camera 300 may increase heat dissipation onto the enclosure 113 removing heat faster from the camera 300 (e.g., the image sensor 108 of the camera 300) and, thus, improve the functionality of the sensor package and increasing a quantity of video modes that the camera 300 can support (e.g., relative to the camera 100 of FIGS. 2A and 2B). Further, the relatively thinner base such that the base does not extend between the flexure 120 and the enclosure 113 at least helps to produce the relatively smaller gap 390 providing a camera module/camera shoulder height reduction, z-height 399 (e.g., compared to the camera module/camera shoulder height, z-height 199) for different sensor mounting configuration. In some embodiments, flexure mounting configurations may decrease the camera module height/camera shoulder height, z-height by about 250 μm so that that z-height 399 of FIGS. 3 and 4 is 250 μm less than the z-height 199 of FIGS. 2A and 2B. Further, the configurations described herein may reduce the warpage requirement for base molding and may allow for a variety of different base manufacturing processes including metal injection molding (MIM).

FIGS. 5 and 6 illustrate components of an example camera 500 having an assembly that may, for example, be used to provide autofocus and/or optical image stabilization through image sensor movement in small form factor cameras, according to at least some embodiments. FIG. 5 shows a cross-sectional view of the camera 500 across the A-A plane. FIG. 6 shows an exploded view of the camera 500. The camera 500 may include one or more same or similar features as the features described with respect to or illustrated in FIGS. 1, 2A, 2B, 3, 4, 7, 8, 9, and 10. The example X-Y-Z coordinate system shown in FIGS. 5 and 6 may be used to discuss aspects of components and/or systems, and may apply to embodiments described throughout this disclosure. The flexure 520 retaining the image sensor 108 may be attached to the base 314 of the camera with a relatively thinner portion that does not extend below the flexure 520 (e.g., the static platform 515) (e.g., between the flexure 520 and the enclosure 113).

FIGS. 5 and 6 illustrate a camera 500 (e.g., a camera module) with a relatively smaller gap 590 (e.g., compared to the gap 190 of the camera 100 of FIGS. 2A and 2B, compared to the gap 390 of the camera 300 of FIGS. 3 and 4) between the image sensor 108 and the enclosure 113 of the camera 500 and due at least in part to the absence of the fender 153 illustrated in FIGS. 2A and 2B and/or due at least in part to the absence of the image sensor stiffener 152 illustrated in FIGS. 2A, 2B, 3, and 4. The relatively smaller gap 590 formed between the image sensor 108 and the enclosure 113 of the camera 500 may increase the amount of heat dissipation through the enclosure 113 generated by the image sensor 108 and, thus, may improve the functionality of the sensor package and increase a quantity of video modes that the camera 500 can support. For example, the camera 500 may be able to support 4K120FPS mode and may support 8K30FPS mode. For instance, with the camera 100, when the image sensor 127 uses a power mode of 4K120FPS, the peak temperature at the image sensor may be 70.2 degrees Celsius. Conversely, with the camera 500, when the image sensor 127 uses the power mode of 4K120FPS, the peak temperature at the image sensor may be 63.2 degrees Celsius. Thus, the configuration of camera 500 is about 7 degrees Celsius less than the camera 100 when the image sensor 127 uses the power mode of 4K120FPS. As another instance, with the camera 100, when the image sensor 127 uses a power mode of 8K30FPS, the peak temperature at the image sensor may be 95.2 degrees Celsius. Conversely, with the camera 500, when the image sensor 127 uses the power mode of 8K30FPS, the peak temperature at the image sensor may be 84.2 degrees Celsius. Thus, the configuration of camera 500 is about 11 degrees Celsius less than the camera 100 when the image sensor 127 uses the power mode of 8K30FPS. In addition, the flexure 520 (e.g., the static platform 515) attached to a downward facing seat 361 of the base 314 and the thinness of the base 314 below the static platform 115 of the flexure 120 such that the base does not extend below the flexure 120 (e.g., the static platform 515) (e.g., between the flexure 520 and the enclosure 113) may produce a relatively smaller gap 590 between the image sensor 108 and the enclosure 113 of the camera 500 relative to the gap 190 illustrated in FIGS. 2A and 2B and the gap 390 illustrated in FIGS. 3 and 4. This smaller gap 590 directly reduces the camera shoulder height 599 and lens top height improving system fit. In addition, the camera 500 does not include a fender or a sensor stiffener. Instead, the dynamic platform 521 of the flexure 520 extends completely below the image sensor 108 such that no aperture is present through the dynamic platform along the optical axis 101 eliminating the need for a fender and/or a sensor stiffener and further reducing the size of the gap 590 relative to the gap 190 of FIGS. 2A and 2B and relative to the gap 390 of FIGS. 3 and 4.

As shown in FIGS. 5 and 6, the camera 500 includes an optical axis 101, and an optical assembly 103 including one or more lens(es) 102. A lens carrier 128 may retain the optical assembly 103. The lens carrier 128 may include one or more auto focus (AF) coil(s) 118 positioned circumferentially around the optical assembly 103 and the optical axis 101. A magnet holder 106 may be fixedly attached to a static shield can 110. The magnet holder 106 may include one or more magnets for magnetically interacting with the AF coil(s) 118 when current flows through the AF coil(s) 118 to move the lens carrier 128 and the optical assembly 103 along the optical axis (z) 101 for auto focus. The magnets and AF coil(s) 118 may together be considered voice coil motor (VCM) actuators that utilize Lorentz forces to move the lens carrier 128 and the optical assembly 103 along the optical axis (z) 101 for auto focus. When Lorentz forces cause movement of the lens carrier 128 and the optical assembly 103 along the optical axis 101, respective AF springs 150 fixedly attached to the magnet holder 106 (and thus a static portion of the camera 500) and fixedly attached to the lens carrier 128 may be used to dampen movement of the lens carrier 128 and the optical assembly 103 along the optical axis 101 relative to the magnet holder 106 and/or the shield can 110.

The camera 500 also includes an image sensor 108, one or more filter(s) 122a, a substrate 534 (e.g., an OIS FPC, printed circuit board, and/or the like) including an upper substrate 534a and a lower substrate 534b, a flexure 520, a base 314, the shield can 110, and an enclosure 130. The shield can 110 may be mechanically attached to the base 314. The shield can 110 may be mechanically coupled to the base 314 via the enclosure 113 attached to both the shield can 110 and the base 314. The flexure 520 may include a dynamic platform 521, a static platform 515, and a plurality of flexure arms 524. The image sensor 108 may be retained by the dynamic platform 521 so that image sensor 108 moves as the dynamic platform 521 moves relative to a static portion of the camera 500. The plurality of flexure arms 524 may provide a flexible mechanical coupling between the static platform 515 and the dynamic platform 521. For example, the flexure arms 524 may allow the dynamic platform 521 (and thus the image sensor 108) to move in one or more directions orthogonal to the optical axis 101 relative to the static platform 515 (e.g., a remainder of the camera 300) using one or more transversal actuators. For example, OIS coils 119 (e.g., as shown in FIG. 6) positioned on the substrate 534 may interact with magnets in the magnet holder 106 to create Lorentz forces to move the dynamic platform 521 and the image sensor 108 in one or more directions orthogonal to the optical axis 101 relative to the static platform 515 (e.g., a remainder of the camera 500). In some aspects, the flexure arms 524 may allow the dynamic platform 521 (and thus the image sensor 108) to move in one or more directions parallel to or along the optical axis 101 relative to the static platform 515 (e.g., a remainder of the camera 500) using one or more axial actuators. Additionally, the flexure arms 524 may allow the dynamic platform 521 (and thus the image sensor 108) to move in one or more angular directions about one or more axes orthogonal to the optical axis 101 relative to the static platform 515 (e.g., a remainder of the camera 500) using one or more axial actuators.

Unlike the flexure 120 of FIGS. 2A, 2B, 3, and 4, the flexure 520 may include a dynamic platform 521 that extends completely under the image sensor 108 so that no aperture exists through the dynamic platform 521 that intersects with the optical axis 101. Extending the dynamic platform 521 completely across the image sensor 108 may remove the need for a fender or a sensor stiffener to protect the image sensor 108 when the dynamic platform is fully extended and grounded against the enclosure 113 may further reduce the size of the gap 590 compared to the gap 390 and the gap 190. In some aspects, one or more end stops 553 (e.g., formed of polyimide (PI)) may be attached to an underside of the dynamic platform 521 to dampen contact between the dynamic platform 521 and the enclosure 113.

In some aspects, the flexure arms 524 may include electrical traces for communicating electrical power and electrical signals between the dynamic platform 521 (e.g., one or more electronic components (e.g., electronic components 151) mounted (e.g., surface mounted) on the substrate (e.g., substrate upper block 534a), the image sensor 108 mounted on the substrate (e.g., the substrate lower block 534b), one or more electronic components mounted to the dynamic platform 521, or the like) and the static platform 515. The static platform 515 may be fixedly attached to the base 314 via one or more seats 361. For example, the base 314 may include one or more seats 361 facing a direction parallel with the optical axis 101 and facing away from the optical assembly 103. The static platform 515 may reside on the seats 361 and may be in electrical communication with one or more other components of the camera 500 (e.g., via the electrical connection(s) 104 illustrated in FIG. 1) for performing one or more camera operations via the base 314.

In some non-limiting examples, the image sensor 108 may be connected to the OIS frame or flexure 520 directly. For example, the dynamic platform 521 may retain both the substrate 534 (e.g., the substrate upper block 534a, the substrate lower block 534b) for mounting one or more electronic components 151 and the image sensor 108. One or more wire bonds 552 may electrically connect the image sensor 108 residing on the dynamic platform 521 to the dynamic platform 521. In some aspects, the substrate 534 (e.g., the substrate upper block 534a and/or the substrate lower block 534b) may be formed of an organic material. For example, the substrate upper block 534a may be formed of an organic material and the substrate lower block 534b may also be formed of an organic material. Forming the substrate 534 of organic material may better facilitate electrical transmissions compared to ceramic material. The substrate 534 may include an opening with a cross-section sized to permit light to pass therethrough to the image sensor 108 while also receiving or retaining the filter(s) 122. An upper surface of the substrate 534 (e.g., of the substrate lower block 534b) may retain the filter(s) 122 around a perimeter of the opening while the dynamic platform 521 attached to the substrate lower block 534b may retain the image sensor 108. This configuration may allow light to pass from the lens(es) of the optics assembly 103, through the filter(s) 122, and be received by the filter(s) 122 and the image sensor 108 for image capturing (e.g., a light receiving surface of the image sensor for image capturing).

The camera 500 (e.g., a camera module) may have a relatively smaller gap 590 (e.g., compared to at least the gap 190 of the camera 100 of FIGS. 2A and 2B and compared to at least the gap 390 of the camera 300 of FIGS. 3 and 4) between the image sensor 108 and the enclosure 113 of the camera 500. The relatively smaller gap 590 formed between the image sensor 108 and the enclosure 113 of the camera 500 may enhance the amount of heat dissipation through the enclosure 113 generated by the image sensor 108 and, thus, may improve the functionality of the sensor package and increase a quantity of video modes that camera 500 can support (e.g., relative to the camera 100 of FIGS. 2A and 2B and relative to the camera 300 of FIGS. 3 and 4). For example, the camera 500 may improve the support 4k/120 fps mode and may support 8k/30 fps mode.

The flexure 520 may be attached to the base 314 such that the static platform 515 of the flexure 520 may be attached to the downward facing seat 361 (e.g., a seat facing in a direction parallel to the optical axis and away from the optics assembly and/or the lenses 102) of the base 314 rather than an upward facing seat (e.g., a seat facing in a direction parallel to the optic axis and towards to the optics assembly and/or the lenses 102, the seat 161 of FIGS. 2A and 2B) and may allow the image sensor 108 and the dynamic platform 521 to move (e.g., away from the optical assembly 103 and/or the lenses 102) to the enclosure 113 so that the image sensor 108 (e.g., the dynamic platform 521, the end stops 553) makes direct contact with the enclosure 113 rather than through a midframe of the base 314 (e.g., the base 114 of FIGS. 2A and 2B, the fender 153 of FIGS. 2A and 2B). The flexure 520 (e.g., the static platform 515) being attached to a downward facing seat 361 of the base 314 with a relatively thin portion that does not extend below the flexure 520 (e.g., the static platform 515) (e.g., between the flexure 120 and the enclosure 113) may produce a smaller gap 590 between the image sensor 108 and the enclosure 113 of the camera 500 relative to the gap 190 and the gap 390. In some aspects, one or more end stops 553 (e.g., formed of polyimide (PI)) may be attached to an underside of the dynamic platform 521 to dampen contact between the dynamic platform 521 and the enclosure 113. Further, unlike the flexure 120 of FIGS. 2A, 2B, 3, and 4, the flexure 520 including the dynamic platform 521 extends completely under the image sensor 108 so that no aperture exists through the dynamic platform 521 that intersects with the optical axis 101. Extending the dynamic platform 521 completely across and underneath the image sensor 108 may remove the need for a fender or a sensor stiffener to protect the image sensor 108 when the dynamic platform is fully extended and grounded against the enclosure 113 further reduce the gap 590 compared to the gap 190 and the gap 390.

The relatively small gap 590 between the image sensor 108 and the enclosure 113 of the camera 500 may increase heat dissipation onto the enclosure 113 removing heat faster from the camera 500 (e.g., the image sensor 108 of the camera 500) and, thus, improve the functionality of the sensor package (e.g., the image sensor 108) and increasing a quantity of video modes that the camera 500 can support (e.g., relative to the camera 100 of FIGS. 2A and 2B). Further, the relatively thinner base such that the base does not extend between the flexure 520 and the enclosure 113 at least helps to produce the relatively smaller gap 590 providing a camera module/camera shoulder height reduction, z-height 599 (e.g., compared to the camera module/camera shoulder height, z-height 199 and to the camera module/camera shoulder height, z-height 399) (and/or lens top height) for different sensor mounting configuration. The relatively small gap 590 may be located between the flexure 520 (e.g., the dynamic platform 521, the end stop 553) and the enclosure 113 such that no object exists in the relatively small gap 509 between the flexure 520 (e.g., the dynamic platform 521, the end stop 553) and the enclosure 113. In other words, the flexure 520 (e.g., the dynamic platform 521, the end stop 553) may be the closest moving part of the camera 500 to the enclosure 113 (e.g., at or near the optical axis 101). In some embodiments, flexure mounting configurations may decrease the camera module height/camera shoulder height, z-height by about 400 μm so that that z-height 599 of FIGS. 5 and 6 is 400 μm less than the z-height 199 of FIGS. 2A and 2B. In some embodiments, flexure mounting configurations may decrease the module height by about 400 μm. Additionally, in some embodiments, a wire bond 552 may electrically connect the image sensor to the flexure for improved electronic signal transmissions. Further, the configurations described herein may reduce the warpage requirement for base molding and may allow for a variety of different base manufacturing processes including metal injection molding (MIM).

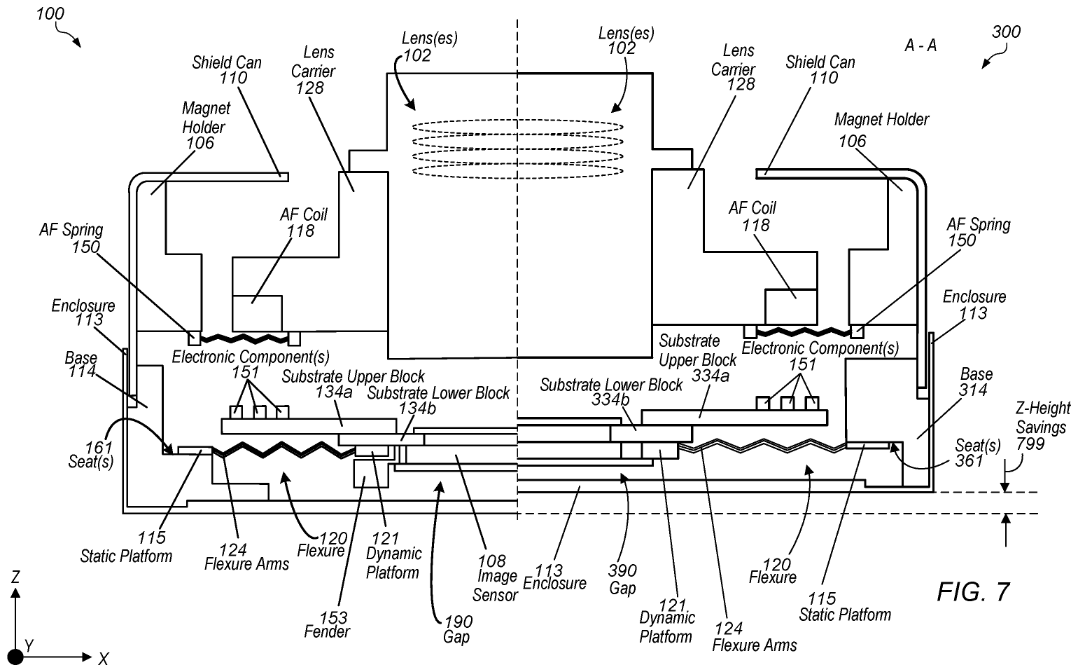

FIG. 7 illustrates a cross-sectional comparison between the camera 100 illustrated in FIGS. 2A and 2B and the camera 300 illustrated in FIGS. 3 and 4. As described herein, the camera 300 (e.g., a camera module) has a relatively smaller gap 390 compared to the gap 190 of the camera 100 between the image sensor 108 and the enclosure 113 of the camera 300. This is due at least in part to the absence of the fender 153 included in the camera 100. The relatively smaller gap 390 formed between the image sensor 108 and the enclosure 113 of the camera 300 may increase the amount of heat dissipation through the enclosure 113 generated by the image sensor 108 and, thus, may improve the functionality of the sensor package and increase a quantity of video modes that the camera 300 can support. For example, the camera 300 may be able to support 4K120FPS mode and may support 8K30FPS mode. For instance, with the camera 100, when the image sensor 127 uses a power mode of 4K120FPS, the peak temperature at the image sensor may be 70.2 degrees Celsius. Conversely, with the camera 300, when the image sensor 127 uses the power mode of 4K120FPS, the peak temperature at the image sensor may be 63.2 degrees Celsius. Thus, the configurations of camera 300 is about 7 degrees Celsius less than the camera 100 when the image sensor 127 uses the power mode of 4K120FPS. As another instance, with the camera 100, when the image sensor 127 uses a power mode of 8K30FPS, the peak temperature at the image sensor may be 95.2 degrees Celsius. Conversely, with the camera 300, when the image sensor 127 uses the power mode of 8K30FPS, the peak temperature at the image sensor may be 84.2 degrees Celsius. Thus, the configuration of camera 300 is about 11 degrees Celsius less than the camera 100 when the image sensor 127 uses the power mode of 8K30FPS. In addition, the flexure 120 (e.g., the static platform 115) attached to a downward facing seat 361 of the base 314 and the thinness of the base 314 below the static platform 115 of the flexure 120 such that the base does not extend below the flexure 120 (e.g., the static platform 115) (e.g., between the flexure 120 and the enclosure 113) may produce a relatively smaller gap 390 between the image sensor 108 and the enclosure 113 of the camera 300 relative to the gap 190. This smaller gap 390 directly reduces the camera shoulder height 399 and lens top height improving system fit. For example, as shown in FIG. 7, the smaller gap 390 of the camera 300 may provide the camera 300 with a z-height savings 799 of about 250 μm compared to the camera 100.

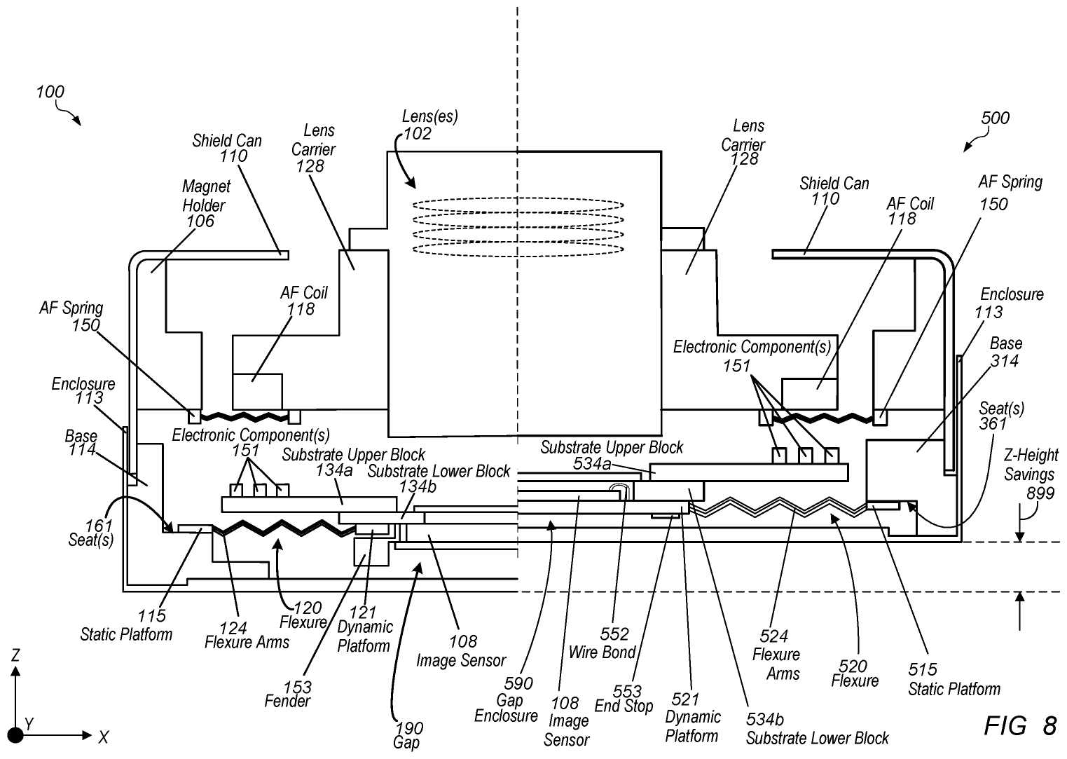

FIG. 8 illustrates a cross-sectional comparison between the camera 100 illustrated in FIGS. 2A and 2B and the camera 500 illustrated in FIGS. 5 and 6. As described herein, the camera 500 (e.g., a camera module) has a relatively smaller gap 590 compared to the gap 190 of the camera 100 and the gap 390 of the camera 300 between the image sensor 108 and the enclosure 113 of the camera 500. This is due at least in part to the absence of the fender 153 included in the camera 100 and/or the absence of the image sensor stiffener 152 illustrated in FIGS. 2A, 2B, 3, and 4. The relatively smaller gap 590 formed between the image sensor 108 and the enclosure 113 of the camera 500 may increase the amount of heat dissipation through the enclosure 113 generated by the image sensor 108 and, thus, may improve the functionality of the sensor package and increase a quantity of video modes that the camera 500 can support. For example, the camera 500 may be able to support 4K120FPS mode and may support 8K30FPS mode. For instance, with the camera 100, when the image sensor 127 uses a power mode of 4K120FPS, the peak temperature at the image sensor may be 70.2 degrees Celsius. Conversely, with the camera 500, when the image sensor 127 uses the power mode of 4K120FPS, the peak temperature at the image sensor may be 63.2 degrees Celsius. Thus, the configuration of camera 500 is about 7 degrees Celsius less than the camera 100 when the image sensor 127 uses the power mode of 4K120FPS. As another instance, with the camera 100, when the image sensor 127 uses a power mode of 8K30FPS, the peak temperature at the image sensor may be 95.2 degrees Celsius. Conversely, with the camera 500, when the image sensor 127 uses the power mode of 8K30FPS, the peak temperature at the image sensor may be 84.2 degrees Celsius. Thus, the configuration of camera 500 is about 11 degrees Celsius less than the camera 100 when the image sensor 127 uses the power mode of 8K30FPS. In addition, the flexure 520 (e.g., the static platform 515) attached to a downward facing seat 361 of the base 314 and the thinness of the base 314 below the static platform 115 of the flexure 120 such that the base does not extend below the flexure 120 (e.g., the static platform 515) (e.g., between the flexure 520 and the enclosure 113) may produce a relatively smaller gap 590 between the image sensor 108 and the enclosure 113 of the camera 500 relative to the gap 190 illustrated in FIGS. 2A and 2B and the gap 390 illustrated in FIGS. 3 and 4. This smaller gap 590 directly reduces the camera shoulder height 599 and lens top height improving system fit. In addition, the camera 500 does not include a fender or a sensor stiffener. Instead, the dynamic platform 521 of the flexure 520 extends completely below the image sensor 108 such that no aperture is present through the dynamic platform along the optical axis 101 eliminating the need for a fender and/or a sensor stiffener and further reducing the size of the gap 590 relative to the gap 190 of FIGS. 2A and 2B and relative to the gap 390 of FIGS. 3 and 4. As shown in FIG. 8, the smaller gap 590 of the camera 500 may provide the camera 500 with a z-height savings 899 of about 400 μm compared to the camera 100.

FIG. 9 illustrates a schematic representation of an example device 900 that may include a camera (e.g., as described herein with respect to FIGS. 1, 2A, 2B, 3, 4, 5, 6, 7, 8, and 10), in accordance with some embodiments. In some embodiments, the device 900 may be a mobile device and/or a multifunction device. In various embodiments, the device 900 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 900 may include a display system 902 (e.g., comprising a display and/or a touch-sensitive surface) and/or one or more cameras 904. In some non-limiting embodiments, the display system 902 and/or one or more front-facing cameras 904a may be provided at a front side of the device 900, e.g., as indicated in FIG. 9. Additionally, or alternatively, one or more rear-facing cameras 904b may be provided at a rear side of the device 900. In some embodiments comprising multiple cameras 904, some or all of the cameras may be the same as, or similar to, each other. Additionally, or alternatively, some or all of the cameras may be different from each other. In various embodiments, the location(s) and/or arrangement(s) of the camera(s) 904 may be different than those indicated in FIG. 9.

Among other things, the device 900 may include memory 906 (e.g., comprising an operating system 908 and/or application(s)/program instructions 910), one or more processors and/or controllers 912 (e.g., comprising CPU(s), memory controller(s), display controller(s), and/or camera controller(s), etc.), and/or one or more sensors 916 (e.g., orientation sensor(s), proximity sensor(s), and/or position sensor(s), etc.). In some embodiments, the device 900 may communicate with one or more other devices and/or services, such as computing device(s) 918, cloud service(s) 920, etc., via one or more networks 922. For example, the device 900 may include a network interface (e.g., network interface 910) that enables the device 900 to transmit data to, and receive data from, the network(s) 922. Additionally, or alternatively, the device 900 may be capable of communicating with other devices via wireless communication using any of a variety of communications standards, protocols, and/or technologies.

FIG. 10 illustrates a schematic block diagram of an example computing device, referred to as computer system 1000, that may include or host embodiments of a camera (e.g., as described herein with respect to FIGS. 1, 2A, 2B, 3, 4, 5, 6, 7, 8, and 9). In addition, computer system 1000 may implement methods for controlling operations of the camera and/or for performing image processing images captured with the camera including the cameras 100, 300, and 500 described herein. In some embodiments, the device 1000 (described herein with reference to FIG. 10) may additionally, or alternatively, include some or all of the functional components of the computer system 700 described herein.

The computer system 1000 may be configured to execute any or all of the embodiments described above. In different embodiments, computer system 1000 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1000 includes one or more processors 1002 coupled to a system memory 1004 via an input/output (I/O) interface 1006. Computer system 1000 further includes one or more cameras 1008 coupled to the I/O interface 1006. Computer system 1000 further includes a network interface 1010 coupled to I/O interface 1006, and one or more input/output devices 1012, such as cursor control device 1014, keyboard 1016, and display(s) 1018. In some cases, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1002, or a multiprocessor system including several processors 1002 (e.g., two, four, eight, or another suitable number). Processors 1002 may be any suitable processor capable of executing instructions. For example, in various embodiments processors 1002 may be general-purpose or embedded processors implementing any of a variety of instruction set architectures (ISAs), such as the x86, PowerPC, SPARC, or MIPS ISAs, or any other suitable ISA. In multiprocessor systems, each of processors 1002 may commonly, but not necessarily, implement the same ISA.

System memory 1004 may be configured to store program instructions 1020 accessible by processor 1002. In various embodiments, system memory 1004 may be implemented using any suitable memory technology, such as static random access memory (SRAM), synchronous dynamic RAM (SDRAM), nonvolatile/Flash-type memory, or any other type of memory. Additionally, existing camera control data 1022 of memory 1004 may include any of the information or data structures described above. In some embodiments, program instructions 1020 and/or data 1022 may be received, sent or stored upon different types of computer-accessible media or on similar media separate from system memory 1004 or computer system 1000. In various embodiments, some or all of the functionality described herein may be implemented via such a computer system 1000.

In one embodiment, I/O interface 1006 may be configured to coordinate I/O traffic between processor 1002, system memory 1004, and any peripheral devices in the device, including network interface 1010 or other peripheral interfaces, such as input/output devices 1012. In some embodiments, I/O interface 1006 may perform any necessary protocol, timing or other data transformations to convert data signals from one component (e.g., system memory 1004) into a format suitable for use by another component (e.g., processor 1002). In some embodiments, I/O interface 1006 may include support for devices attached through various types of peripheral buses, such as a variant of the Peripheral Component Interconnect (PCI) bus standard or the Universal Serial Bus (USB) standard, for example. In some embodiments, the function of I/O interface 1006 may be split into two or more separate components, such as a north bridge and a south bridge, for example. Also, in some embodiments some or all of the functionality of I/O interface 1006, such as an interface to system memory 1004, may be incorporated directly into processor 1002.

Network interface 1010 may be configured to allow data to be exchanged between computer system 1000 and other devices attached to a network 1024 (e.g., carrier or agent devices) or between nodes of computer system 1000. Network 1024 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1010 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1012 may, in some embodiments, include one or more display terminals, keyboards, keypads, touchpads, scanning devices, voice or optical recognition devices, or any other devices suitable for entering or accessing data by one or more computer systems 1000. Multiple input/output devices 1012 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1010.

Those skilled in the art will appreciate that computer system 1000 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly having one or more lens defining an optical axis;
an image sensor;
an enclosure forming an exterior wall of the camera;
an actuator assembly to move the image sensor relative to the optical assembly;
a base that is a static component of the camera, wherein the base comprises a seat that faces in a direction that is parallel to the optical axis and away from the optical assembly; and
a flexure that is attached to the seat, that suspends the image sensor from the base, and that allows motion of the image sensor enabled by the actuator assembly.

2. The camera of claim 1, further comprising a substrate providing electronic communication between one or more surface mounted electrical components residing on the substrate and the image sensor, wherein the image sensor is fixedly attached to a surface of the substrate that faces in the direction that is parallel to the optical axis and away from the optical assembly, wherein the substrate comprises an upper block formed of an organic material and a lower block formed of a ceramic material.

3. The camera of claim 2, further comprising an image sensor stiffener that extends over at least a portion of the flexure, wherein the image sensor stiffener is the closest moving component of the camera to the enclosure.

4. The camera of claim 1, further comprising a substrate providing electronic communication between one or more surface mounted electrical components residing on the substrate and the image sensor via the flexure, wherein the flexure is fixedly attached to a surface of the substrate that faces in the direction that is parallel to the optical axis and away from the optical assembly, wherein the substrate comprises an upper block and a lower block formed of an organic material.

5. The camera of claim 4, wherein the flexure extends completely across a surface of the image sensor that faces in the direction that is parallel to the optical axis and away from the optical assembly, wherein the flexure is the closest moving component of the camera to the enclosure.

6. The camera of claim 4, further comprising an end stop fixedly attached to a surface of the flexure that faces in the direction that is parallel to the optical axis and away from the optical assembly, wherein the end stop is the closest moving component of the camera to the enclosure.

7. The camera of claim 4, further comprising a wire bond providing electronic communication between the image sensor and the flexure.

8. A device, comprising:
one or more processors;
memory storing program instructions executable by the one or more processors to control operation of a camera; and
the camera comprising:
an optical assembly having one or more lens defining an optical axis,
an image sensor,
an enclosure forming an exterior wall of the camera,
an actuator assembly to move the image sensor relative to the optical assembly,
a base that is a static component of the camera, wherein the base comprises a seat that faces in a direction that is parallel to the optical axis and away from the optical assembly, and
a flexure that is attached to the seat, that suspends the image sensor from the base, and that allows motion of the image sensor enabled by the actuator assembly.

9. The device of claim 8, wherein the camera further comprises a substrate providing electronic communication between one or more surface mounted electrical components residing on the substrate and the image sensor, wherein the image sensor is fixedly attached to a surface of the substrate that faces in the direction that is parallel to the optical axis and away from the optical assembly, wherein the substrate comprises an upper block formed of an organic material and a lower block formed of a ceramic material.

10. The device of claim 9, wherein the camera further comprises an image sensor stiffener that extends over at least a portion of the flexure, wherein the image sensor stiffener is the closest moving component of the camera to the enclosure.

11. The device of claim 8, wherein the camera further comprises a substrate providing electronic communication between one or more surface mounted electrical components residing on the substrate and the image sensor via the flexure, wherein the flexure is fixedly attached to a surface of the substrate that faces in the direction that is parallel to the optical axis and away from the optical assembly, wherein the substrate comprises an upper block and a lower block formed of a ceramic material.

12. The device of claim 11, wherein the flexure extends completely across a surface of the image sensor that faces in the direction that is parallel to the optical axis and away from the optical assembly, wherein the flexure is the closest moving component of the camera to the enclosure.

13. The device of claim 11, further comprising an end stop fixedly attached to a surface of the flexure that faces in the direction that is parallel to the optical axis and away from the optical assembly, wherein the end stop is the closest moving component of the camera to the enclosure.

14. The device of claim 11, further comprising a wire bond providing electronic communication between the image sensor and the flexure.

15. An image sensor actuator assembly, comprising:
an image sensor;
an actuator assembly to move the image sensor in one or more direction relative to an axis that is orthogonal to a light receiving surface of the image sensor;
an enclosure forming an exterior wall of the camera;
a base that is fixedly attached to the enclosure, wherein the base comprises a seat that faces in a direction that is parallel to the axis and faces in an opposite direction of the light receiving surface of the image sensor; and
a flexure that is attached to the seat, that suspends the image sensor from the base, and that allows motion of the image sensor enabled by the actuator assembly.

16. The image sensor actuator assembly of claim 15, further comprising a substrate providing electronic communication between one or more surface mounted electrical components residing on the substrate and the image sensor, wherein the image sensor is fixedly attached to a surface of the substrate that faces in the direction that is parallel to the axis and that faces in the opposite direction of the light receiving surface of the image sensor, wherein the substrate comprises an upper block formed of an organic material and a lower block formed of a ceramic material.

17. The image sensor actuator assembly of claim 16, further comprising an image sensor stiffener that extends over at least a portion of the flexure, wherein the image sensor stiffener is the closest moving component of the camera to the enclosure.

18. The image sensor actuator assembly of claim 15, further comprising a wire bond providing electronic communication between the image sensor and the flexure and a substrate providing electronic communication between one or more surface mounted electrical components residing on the substrate and the image sensor via the flexure, wherein the flexure is fixedly attached to a surface of the substrate that faces in the direction that is parallel to the axis and that faces in the opposite direction of the light receiving surface of the image sensor, wherein the substrate comprises an upper block and a lower block formed of an organic material.

19. The image sensor actuator assembly of claim 15, wherein the flexure extends completely across a surface of the image sensor that faces in the direction that is parallel to the axis and that faces in the opposite direction of the light receiving surface of the image sensor, wherein the flexure is the closest moving component of the camera to the enclosure.

20. The image sensor actuator assembly of claim 15, further comprising an end stop fixedly attached to a surface of the flexure that faces in the direction that is parallel to the axis and that faces in the opposite direction of the light receiving surface of the image sensor, wherein the end stop is the closest moving component of the camera to the enclosure.
